(19) United States
(12) Patent Application Publication
(10) Pub. No.: US 2014/0251070 A1
(43) Pub. Date: Sep. 11, 2014

(54) MACHINE CONTROLLER HAVING JOYSTICK AND ADJUSTABLE HANDS-FREE LOCKING MECHANISM

(71) Applicant: Brenton Arthur Kornelson, Victoria (CA)

(72) Inventor: Brenton Arthur Kornelson, Victoria (CA)

(21) Appl. No.: 13/791,022

(22) Filed: Mar. 8, 2013

(51) Int. Cl. G05G 1/04

(52) U.S. Cl. CPC G05G 1/04
USPC 74/523

(57) ABSTRACT

A joystick controller includes a pivotally mounted joystick having a detent plate assembly having a cam surface around the perimeter of the plate, wherein the detent plate is slidably mounted on the joystick shaft for sliding translation along the shaft and wherein the lower surface of the detent plate includes an annular channel adjacent the cam surface and which is substantially centered relative to the joystick shaft, and wherein the joystick housing includes a spaced apart array of pin receiving apertures formed in its upper wall, and one or more pins which releasably mount into the pin receiving apertures so as to extend upwardly from the upper wall around the aperture, wherein the pins engage into the annular channel when the joystick shaft is deflected so that, as a pin engages against the cam surface as the shaft is deflected, and the pin slips into the annular channel.

### FIELD OF THE INVENTION

This invention relates the field of joystick controllers and in particular to an improved joystick locking mechanism for holding a joystick in a hands-free deflected position while providing for ease of return of the joystick to its non-deflected position for hands-on operation by a machine equipment operator, wherein the position of the hands-free locking detents are adjustable on the joystick housing.

### BACKGROUND OF THE INVENTION

Joystick controllers are known for controlling the operation of heavy machinery, for example to control the operation of the blade of a bucket or the operation of an arm or winch amongst many other forms of equipment and their operation.

It is sometimes advantageous, such as in a so-called float function in the bucket blade example, or in the operation of a brake in the winch example, to be able to selectively lock the joystick in a hands-free, deflected position. such as for example fully deflected.

In the prior art applicant is aware of U.S. Pat. No. 6,590,171, herein referred to as the Wolf patent, which issued Jul. 8, 2003 to ITT Manufacturing Enterprises, Inc, for the invention of Wolf et al. and entitled Hand Control for Machinery. The Wolf patent describes a joystick that has its lower end within a housing cavity, and where the upper end of the joystick projects upwardly from the housing and forms a handle. The middle portion of the joystick projects through an aperture in an upper wall of the housing. The joystick is pivotally mounted in the cavity at its lower end. A plurality of discrete, separate joystick detents are mounted on the middle portion of the joystick. A plurality of discrete, separate housing detents are mounted on the housing to engage correspondingly positioned joystick detents. The joystick detents are formed on a collar beneath the joystick handle. The collar is biased downwardly by a coil spring so, as taught by Wolf et al., to provide high resilience in deflection of the joystick detent when it engages and disengages a housing detent. As stated by Wolf, a joystick is commonly biased towards a center, or neutral position, although it can he moved in any one of four directions to control a machine. In many cases, the operator must pivot the joystick in one direction and hold it there for an extended period of time. This can be tiring for the operator. Although detents can be located in a cavity where the lower end of the joystick is pivotally mounted, it is crowded in that area, and it is difficult to retrofit detents or repair damaged detents there. A detent system that was readily accessible for retrofit or replacement of damaged parts, and which provided effective biasing of rugged detents, would he value. The Wolf patent is incorporated herein by reference.

### SUMMARY OF THE INVENTION

The joystick controller according to one aspect of the present invention may be characterized as including a normally substantially vertical joystick shaft lying, when vertical, along a vertical axis. The shaft is pivotally mounted on a pivot in a housing for rotation of the shaft about two orthogonal axes of rotation, wherein the axes of rotation are orthogonal to one another and also to the vertical axis. The rotation or deflection of the shaft about the pivot is within a range of motion between the vertical position wherein the shaft is co-axial with the vertical axis, and a deflected position wherein the shaft is angularly deflected about the pivot from the vertical position.

A detent plate assembly, which may be merely a plate having upper and lower surfaces, or a plate in combination with a sleeve, collar or other slide-assisting structure mounted to the plate, is provided having a cam surface around the perimeter of the plate. The cam surface is inclined or sloped radially inwardly from substantially the top surface of the plate to the bottom surface of the plate. In one embodiment not intended to be limiting the cam surface is frusto-conically shaped, that is, is shaped substantially as an inverted truncated cone. The cam surface is substantially symmetric about a corresponding axis of symmetry, wherein the axis of symmetry is co-axial with the longitudinal axis of the shaft. The detent plate or plate assembly (hereinafter collectively referred to as the detent plate) has a central bore therethrough, centered along the axis of symmetry. The shaft is journalled through the bore. The detent plate is slidably and snugly mounted on the shaft, for example by the use of a slide collar and/or sleeve, for sliding translation along the shaft. Advantageously the detent plate does not tilt relative to the shaft.

A resilient centering mechanism urges the joystick to return from its deflected position to its vertical position. A resilient spring cooperates with the detent plate to resiliently urge the detent plate downwardly into a corresponding neutral position on the joystick shaft.

The housing has walls, including an upper wall, defining a cavity in the housing. The upper wall has an aperture centered on the vertical axis, and which opens into the cavity. The pivot is mounted in the cavity. The shaft extends upwardly through the aperture to form a handle at an upper end of the shaft. The detent plate when in its neutral position is above and adjacent to the upper wall of the housing. The lower surface of the detent plate includes an annular channel. The annular channel is adjacent the perimeter cam surface and the rim or edge of the lower surface of the detent plate. The annular channel is substantially centered on the axis of symmetry of the cam surface.

said housing further comprising: (a) a spaced apart array of pin receiving apertures formed in its upper wall, (b) one or more pins which releasably mount into the pin receiving apertures so as to extend upwardly from the upper wall around the aperture, the one or more pins engaging into the annular channel when the shaft is deflected about the pivot, so that, as a first pin of the one or more pins engages against the cam surface as the shaft is deflected, the detent plate assembly slides upwardly against a return biasing force of the spring so as to allow the first pin to slip into the annular channel and the detent plate assembly to lower the annular channel fully onto the first pin to seat the first pin in the annular channel as the shaft is deflected from vertical.

The detent plate rides up and down along the shaft without the detent plate tilting relative to the shaft, thus avoiding binding of the detent plate against the shaft. Such binding of the detent plate on the shaft would increase the friction between the detent plate and the shaft and thus inhibit sliding of the detent plate along the shaft.

Advantageously the protrusions are pins or other stub members which are mounted in holes formed in the upper wall of the housing in radially spaced array around the aperture in the upper wall. For example, there may be four equally radially spaced apart holes around the aperture into which mount replaceable pins or other stub members. The pins or stub members may be mounted merely by a friction fit in the holes. When any one pin or stub member becomes worn or damaged it may be readily replaced, thereby only causing minimal down-time for the machine and operator.

Notwithstanding that the protrusions are discrete or separate from one another in their spaced apart array around the aperture in the upper wall of the housing, one advantage of using an annular channel on the lower surface of the detent plate is that the detent plate may thus rotate around the shaft and the rotation of the detent plate around the shaft will not affect the mating of the protrusions into the annular channel as the annular channel does not require a specific alignment relative to the housing in order for the protrusions to engage the annular channel. In one embodiment, not intended to be limiting, the annular channel is a continuous circular channel of constant width and constant depth all the way around the lower surface of the detent plate.

### BRIEF DESCRIPTION OF THE DRAWINGS

In the drawings, wherein like characters of reference denote corresponding parts in each view:

FIG. 1 is, in front elevation view, the machine controller according to one embodiment of the present invention with the joystick shaft vertically oriented.

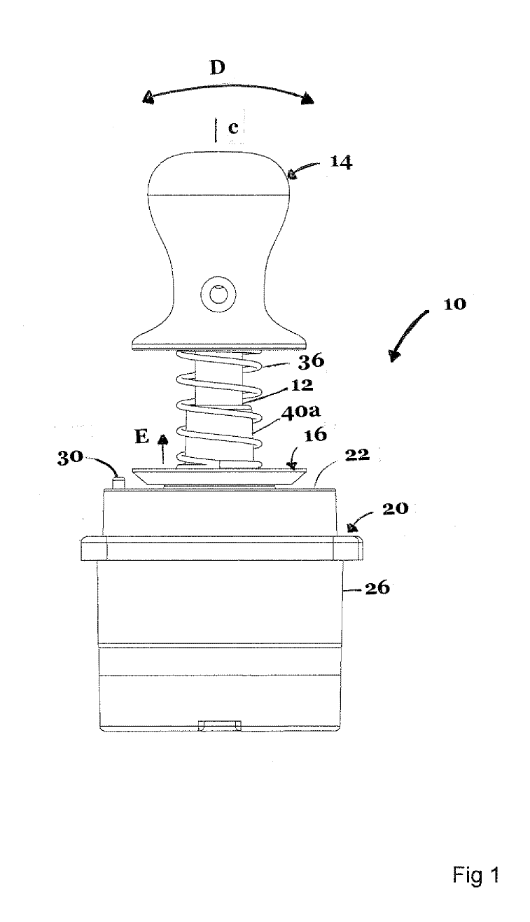

FIG. 2 is, in front perspective view, the machine controller of FIG. 1 with joystick shaft fully deflected from the vertical.

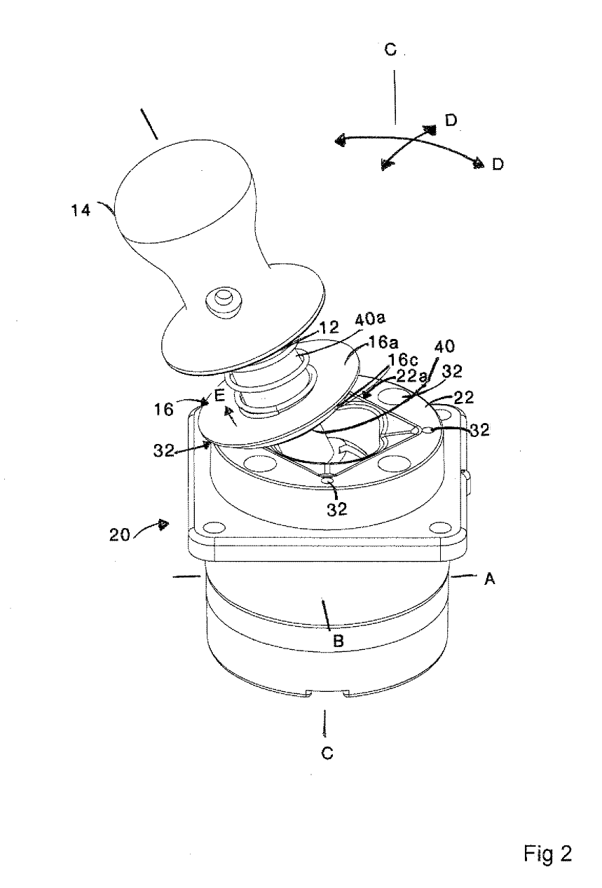

FIG. 3 is a vertical cross-section through the longitudinal axis of the joystick shaft of the machine controller of FIG. 1.

FIG. 4 is the view of FIG. 3 with the joystick shaft partially deflected from the vertical so as to initially engage the cam surface of the detent plate against one of the pins mounted in the upper wall of the housing.

FIG. 5 is the view of FIG. 4 with the joystick shaft further deflected from the vertical so as to elevate the detent plate as the top of the pin passes over the rim of the lower edge of the detent plate.

FIG. 6 is the view of FIG. 5 with the joystick shaft fully deflected so as to mate the pin into the annular channel of the detent plate.

### DETAILED DESCRIPTION OF THE INVENTION

Machine controller 10 includes a joystick shaft 12 having an upper end 12a on which a handgrip 14 is rigidly mounted, a mid-section 12b on which is slidably mounted detent plate or shoe 16, and a lower end 12c which is rigidly mounted to pivot 18. The machine operator operates controller by moving the handgrip 14 in any one of four lateral directions, or in any combination thereof depending on the application. Movement is illustrated as deflection direction D as the lower end 12c of the joystick shaft pivots on pivot 18 about one or both of horizontal perpendicular pivot axes A, B.

Machine controller 10 includes a housing 20 having an upper or top wall 22. An aperture 22a is formed in top wall 22. Aperture 22a may be circular, or clover-leaf or quatre-foil shaped (in plan view) as illustrated, or maybe of another other shape, so long as joystick shaft 12 may deflect sufficiently as described below. A cavity 24 is defined by top wall 22 and by the side and bottom walls 26 and 28 respectively of housing 20. Thus housing 20 is normally open at its top through the aperture 22a in the top wall 22, although as would be understood by those skilled in the art, machine controller 10 maybe oriented so that joystick shaft 12 is not necessarily vertical. The reference herein to a frame of reference wherein top wall 22 is the uppermost wall of housing 20, and where joystick shaft 12 is oriented upwardly is for ease of reference only and not intended to be limiting as it will be understood that machine controller 10 may be oriented and mounted within a machine in other orientations and still work.

In many operations, it is necessary for the operator to hold the joystick pivoted against one of the walls of such aperture 22a for an extended period of time. If the operator's hand must keep the joystick in a deflected or pivoted position, against the force of the return mechanism that urges the joystick back towards the vertical, the operator's hand may tire and such operation will not be hands-free. It may be that the operators hand is required elsewhere so that a hand's free position would be desirable for the operator. Thus an arrangement of detents is provided that holds the joystick at least partially, for example 50 percent, and in a preferred embodiment substantially fully deflected about one or a combination of both of the axes of rotation A, B so that the joystick is inclined towards the housing wall, without requiring the operator to continuously overcome the force of the return mechanism that urges the joystick towards the vertical. The detent arrangement may include four pins or other number of stub members 30 mounted in corresponding holes 32 in top wall 22. Holes 32 and pins 30 may be equally spaced in a radial direction from vertical axis C, and may also be equally radially spaced around axis C so as to, for example, correspond to the operator moving the joystick in four equally spaced directions relative to the top wall 22 such as illustrated or other equally spaced positions relative to housing 20. Although four holes 32 are illustrated, is the number of pins 30 and their positions are not intended to be limiting as different types of machines and corresponding machine operations may require more or less number of pins 30 in various locations around the upper wall of the housing for hands-free holding of the joystick in a deflected position.

Detent plate or shoe 16 may have a ring shaped upper position, which may for example be made of metal such as steel, or made of hard plastic. The upper portion has an upper surface 16a and an oppositely disposed ring shaped lower surface 16b. A frusto-conically shaped perimeter cam surface 16c extends between upper and lower surfaces 16a and 16b. That is, perimeter cam surface 16c may be formed as an inverted frusto-conically shaped cone, although other shapes of such sloped or inclined surfaces would also work (collectively referred to herein as being frusto-conically shaped). An annular channel 34 is formed in lower surface 16b, adjacent cam surface 16c. The annular channel 34 is sized to receive an upwardly protruding protrusion such pin 30 or other stub member in mating engagement therein, and may advantageously be circular and have a constant width and depth. For example pin 30 may be 3 mm long and 3 mm in diameter. Channel 34 may have a depth of 3 mm and a width of 4 mm.

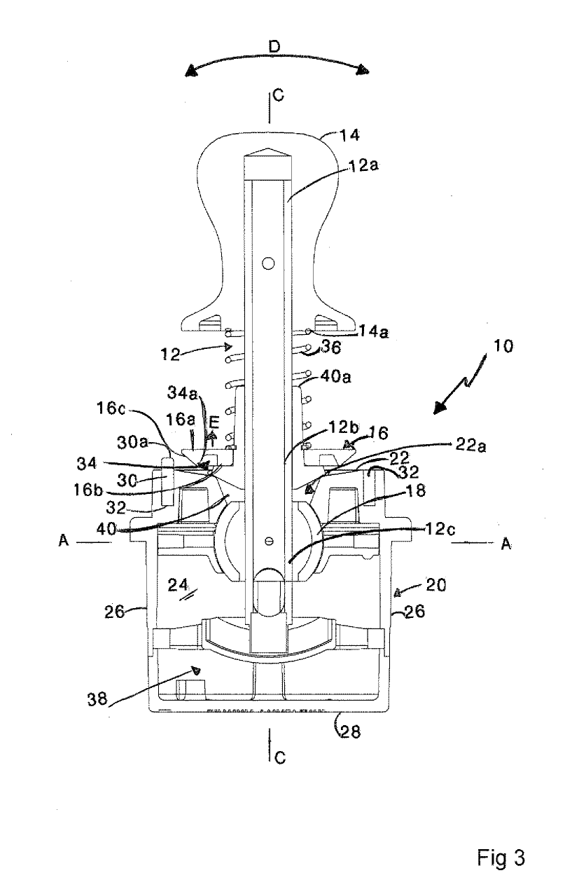

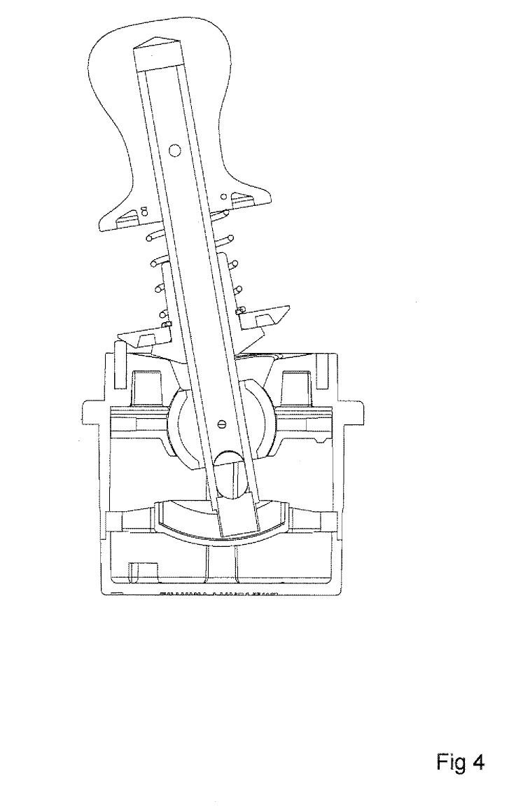

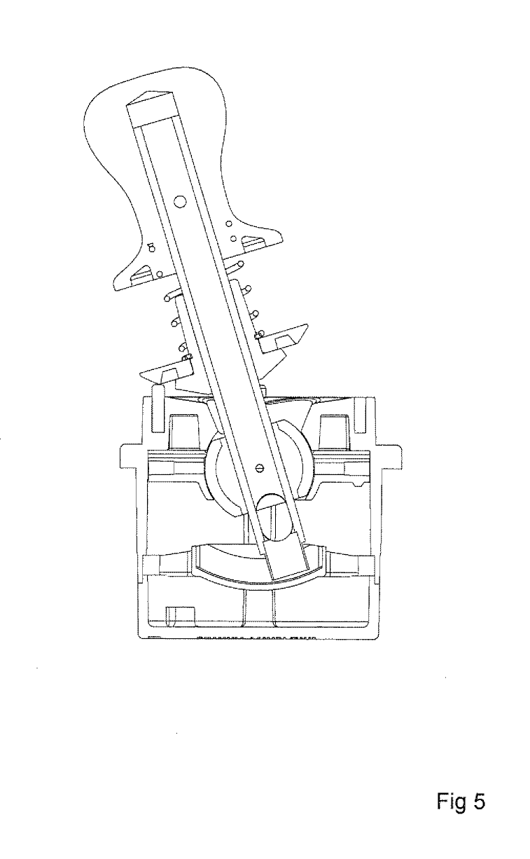

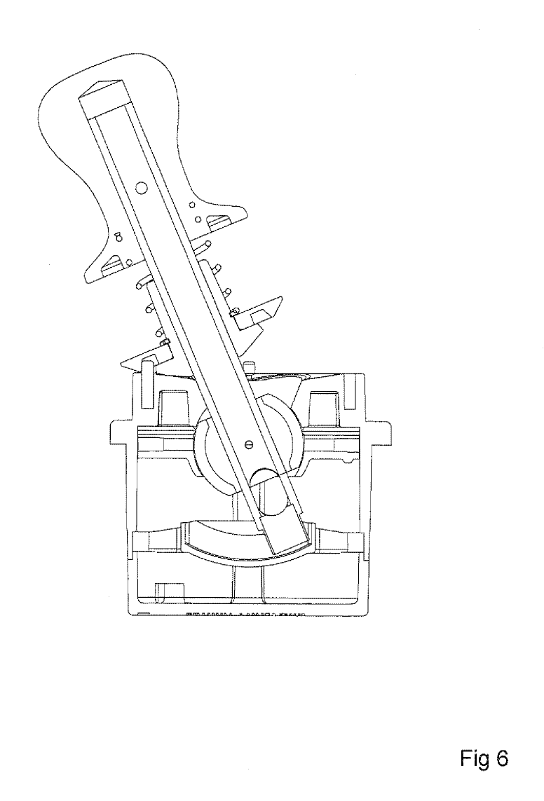

Because channel 34 is continuous, the angular orientation of detent plate 16 relative to joystick shaft 12 does not matter. That is, because annular channel 34 extends all the way around the underside of the detent plate, as the joystick is deflected in direction D from vertical towards its fully deflected position, such as seen in the progression of views in FIGS. 3 to 6, no matter what the angular orientation of detent plate 16 relative to joystick 12, deflecting the joystick shaft 12 to press the detent plate 16 against any one of pins 30 means that one of pins 30 will always engage into channel 34.

A unique aspect of the joystick detent system is the multi detent capability of shoe 16 which makes it possible to not only detent the joystick shaft 12 in its centered position, as is known in the prior art, but also in any deflected position deflected from the vertical, depending on where and how many detent pins are mounted on the top surface 22 of the housing 20. Typically the detent pins will be on axis and at the end of the joystick range of travel. However, a user could require that they be placed at for example a 45 degree angle relative to an axis and at the end of travel or at any point between the center and end of travel.

The shoe design according to the present invention facilitates both a centering detent, as is known in the prior art, together with multiple other detent positions any place a pin is inserted into a pin-hole on the top surface 22 of housing 20 in order to hold the joystick shaft 12 inclined towards and locked onto the pin at that location. Thus the top surface 22 of housing 20 may have a plurality of, for example many, pin-holes 32 formed around the joystick shaft 12 to give a lot of choices to the user as to where to place the detent pins 30.

In operation, pins 30 are mounted in holes 32 in the positions where it is designed to lock the joystick when deflected from the vertical. Consequently, upon such deflection of the joystick, cam surface 16c engages the upper end 30a of a corresponding pin 30. Detent plate 16 is driven a short distance upwardly in direction E along joystick shaft 12, that is, parallel to the longitudinal axis of the joystick shaft 12, against the return biasing force of spring 36. As the pivoting deflection of joystick shaft 12 continues in direction D, upper end 30a of pin 30 slides under cam surface 16c towards lower surface 16b and channel 34. As the deflection of joystick shaft 12 in direction D continues the upper end 30a of pin 30 slides past cam surface 16c, over the rim of lower surface 16b, and into channel 34. As pin 30 enters into channel 34, detent plate 16 returns downwardly in a direction opposite to direction E until pin 30 is fully seated in channel 34 as joystick shaft 12 reaches its fully deflected position.

Advantageously, although without intending to be limiting, radially outward sidewall 34a of channel 34 is sloped so that, with joystick shaft 12 in its fully deflected position, sidewall 34a is flush along the side of upper end 30a of pin 30. That is, sidewall 34a is flared radially outwardly from top to bottom of channel 34.

With pin 30 thus mated in channel 34, joystick shaft 12 is locked in its deflected position, and is hands-free to the operator. When the operator desires to release joystick shaft 12 from the hands-free locked position, the operator exerts a centering force on joystick shaft 12, for example by pressing on handgrip 14 in a direction towards axis C, which urges detent plate to re-elevate in direction E thereby elevating channel 34 up from its locking engagement on pin 30 and releasing the upper end 30a from within channel 34. Once pin 30 is released from annular channel 34, the joystick centering mechanism 38 within housing 20, returns joystick shaft 12 to its centered vertical position on axis C.

In one embodiment not intended to be limiting a slide collar 40 is mounted between detent plate 16 and joystick shaft 12 to assist in maintaining detent plate 16 in its orientation orthogonal to joystick shaft 12, and to assist with the ease which detent plate 16 slides along joystick shaft 12 without binding. Thus slide collar 40 may include an elongate sleeve 40a which extends upwardly from detent plate 16 along joystick shaft 12. Spring 36 may be mounted down onto sleeve 40a so as to extend between the bottom surface 14a of handgrip 14 and the upper surface 16a of detent plate 16.

In one embodiment the pivot 18 may be a ball joint as illustrated, although this is not intended to be limiting as other pivots such as universal joints may also work as would be known to one skilled in the art.

As stated above, while terms such as “upper”, “bottom”, etc. have been used to describe the controller as it is illustrated, the controller may be used in positions tilted or rotated from those shown.

Thus, the invention provides a machine controller where a handgrip 14 may be formed at the upper portion of a joystick shaft 12 which is pivotally mounted within housing 20. A detent arrangement, which enables hands-free operation and ease of positioning of pins 30 is desired positions or housing 20, and ease of replacement of damaged detent parts, includes a plurality of pins 30 or other stub members repleceably mounted in corresponding holes 32 spaced about an aperture 22a in the upper wall 22 of the housing. The pins project above the upper wall to engage an annular channel 34 in the lower surface 166 in a detent plate 16 which is slidably mounted on the joystick shaft 12. The detent plate is mounted on the middle portion of the joystick shaft so as to be positioned above the aperture in the top wall of the housing. The detent plate is slidably mounted on the joystick shaft so that the detent plate elevates along the mid-section of the joystick shaft as the detent plate engages a pin, and lowers as the pin seats into the annular channel. The detent plate is biased towards a spring neutral position by a coil spring 36 that is also mounted on the joystick shaft, for example between the detent plate and the handgrip.

Although particular embodiments of the invention have been described and illustrated herein, it is recognized that modifications and variations may readily occur to those skilled in the art, and consequently, it is intended that the claims be interpreted to cover such modifications and equivalents.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A machine controller comprising:
a normally substantially vertical joystick shaft lying along a vertical axis, said shaft pivotally mounted on a pivot in a housing for rotation of said shaft about one or both of two orthogonal axes of rotation, wherein said axes of rotation are orthogonal to one another and also to said vertical axis, and wherein said pivoting of said shaft is within a range of motion between a vertical position wherein said shaft is co-axial with said vertical axis and a deflected position wherein said shaft is angularly deflected about said pivot from said vertical position,
a detent plate assembly having an upper surface and an opposite lower surface, and a radially inwardly inclined perimeter cam surface which is radially inclined from said upper surface to said lower surface, and wherein said detent plate is symmetric about a longitudinal axis of said shaft, and wherein said detent plate assembly has a central bore therethrough along said longitudinal axis, wherein said shaft is journalled through said bore and wherein said detent plate assembly is slidably mounted on said shaft for sliding translation therealong,
a resilient centering mechanism urging said shaft to return from said deflected position to said vertical position, a resilient spring cooperating with said detent plate assembly to resiliently urge said detent plate assembly downwardly into a neutral position on said shaft, wherein said housing has walls, including an upper wall, defining a cavity in said housing, and wherein said upper wall has an aperture cooperating with and opening into said cavity, and wherein said pivot is mounted in said cavity and said shaft extends through said aperture, and wherein a handle is formed at an upper end of said shaft, and wherein said detent plate assembly, when in said neutral position, is above and adjacent to said upper wall of said housing,
wherein said lower surface of said detent plate assembly, and wherein said lower surface has an annular channel formed therein, said annular channel adjacent said cam surface and substantially symmetric about said longitudinal axis,
said housing further comprising: (a) a spaced apart array of pin receiving apertures formed in said upper wall, (b) one or more pins which releasably mount into said pin receiving apertures so as to extend upwardly from said upper wall around said aperture, said one or more pins engaging into said annular channel when said shaft is deflected about said pivot, so that, as a first pin of said one or more pins engages against said cam surface as said shaft is deflected, said detent plate assembly slides upwardly against a return biasing force of said spring so as to allow said first pin to slip into said annular channel and said detent plate assembly to lower said annular channel fully onto said first pin to seat said first pin in said annular channel as said shaft is deflected from vertical.

2. The controller of claim 1 wherein pin receiving apertures are formed in a radially spaced apart array around said aperture in said upper wall.

3. The controller of claim 2 wherein said one or more pins include four pins and said pin receiving apertures include four equally radially spaced apart holes around said aperture.

4. The controller of claim 2 wherein said pins are removable from said pin-receiving apertures and are mounted in solely a friction fit in said pin-receiving apertures.

5. The controller of claim I wherein said annular channel is a continuous circular channel having constant width and depth.

6. The controller of claim 1 wherein said Cain surface is shaped substantially as an inverted frusto-conical cone.

7. The controller of claim 1 wherein said spaced apart array of said pin-receiving apertures is an equally spaced apart array.

8. The controller of claim 1 wherein said aperture is clover-leaf shaped.

9. The controller of claim 1 wherein said aperture is quatre-foil shaped.

10. The controller of claim 1 wherein said first pin fully seats in said annular channel.

11. The controller of claim 1 wherein said channel has a radially outermost annular side wall which is inclined radially outwardly from said top surface of said detent plate to said bottom surface of said detent plate.

12. The controller of claim 11 wherein said annular side wall is flush against said first pin when said shaft is said fully deflected so as to mate said first pinin said channel.

13. The controller of claim 12 wherein said annular side wall is said inclined at an angle substantially equivalent to a deflection angle of said shaft when said fully deflected.

14. The controller of claim 11 wherein said cam surface is said inclined at a first inclination angle, and wherein said annular side wall is inclined at a second inclination angle, and wherein said first and second inclination angles are of substantially the same magnitude, and said cam surface and said annular side wall are inclined towards one another.

15. The controller of claim 1 wherein said detent plate assembly is snugly mounted on said shaft so that said detent plate assembly does not substantially tilt relative to the shaft.
